(19) United States
(12) Patent Application Publication
(10) Pub. No.: US 2019/0014267 A1
(43) Pub. Date: Jan. 10, 2019

(54) IMAGE CAPTURING APPARATUS

(71) Applicant: CANON KABUSHIKI KAISHA, Tokyo (JP)

(72) Inventor: Shutaro Kunieda, Yokohama-shi (JP)

(21) Appl. No.: 16/020,832

(22) Filed: Jun. 27, 2018

(30) Foreign Application Priority Data
Jul. 7, 2017 (JP) 2017-133939

(51) Int. Cl. H04N 5/232

(52) U.S. Cl. CPC H04N 5/232127

(57) ABSTRACT

An apparatus includes a setting unit configured to set a plurality of areas from which focus detection signals are obtained in an image sensor and a calculation unit configured to perform focus detection calculation of an imaging optical system based on the focus detection signal read from each of the plurality of areas, wherein the setting unit sets a first area and a second area from which focus detection signals are obtained in the image sensor, and the calculation unit calculates a first in-focus position based on a focus detection signal read from the first area and calculates a second in-focus position based on a focus detection signal read from the second area while a focus lens of the imaging optical system is driven based on the first in-focus position.

### BACKGROUND OF THE INVENTION

### Field of the Invention

The aspect of the embodiments relates to an image capturing apparatus of which an image sensor includes a focus detection pixel therein.

### Description of the Related Art

As an automatic focusing method for automatically detecting an in-focus position of a lens, imaging plane automatic focus (AF) is known which uses a focus detection signal, namely an output of a focus detection pixel included in an image sensor for automatic focusing. The method is characterized to be capable of calculating a focus state from focus detection signals for one frame and of detecting an in-focus position in a short time.

For example, Japanese Patent Application Laid-Open No. 2016-72695 describes a technique for calculating an in-focus position from a focus detection pixel during consecutive imaging and improving a consecutive imaging speed by driving a lens during reading of an imaging signal.

### SUMMARY OF THE INVENTION

According to the aspect of the embodiments, an apparatus including an image sensor capable of obtaining a focus detection signal for performing focus detection of an imaging optical system and an imaging signal for generating image data for display includes a setting unit configured to set a plurality of areas from which the focus detection signals are obtained in the image sensor and a calculation unit configured to perform focus detection calculation of the imaging optical system based on the focus detection signal read from each of the plurality of areas, wherein the setting unit sets a first area and a second area from which focus detection signals are obtained in the image sensor, and wherein the calculation unit calculates a first in-focus position based on a focus detection signal read from the first area and calculates a second in-focus position based on a focus detection signal read from the second area while a focus lens of the imaging optical system is driven based on the first in-focus position.

Further features of the present disclosure will become apparent from the following description of exemplary embodiments with reference to the attached drawings.

### BRIEF DESCRIPTION OF THE DRAWINGS

FIG. 1 is an outline view illustrating an entire image capturing apparatus system according to an exemplary embodiment of the disclosure.

FIG. 2 is a block diagram illustrating a configuration of an image capturing apparatus.

FIG. 3 is a schematic drawing illustrating a pixel array of an image sensor.

FIGS. 4A and 4B are a schematic plan view and a schematic cross-sectional view of a pixel.

FIG. 5 is a flowchart illustrating a consecutive imaging sequence.

FIG. 6 illustrates an image reading area.

FIGS. 7A and 7B are timing charts of image reading orders.

FIG. 8 illustrates calculation of an imaging plane automatic focus (AF).

### DESCRIPTION OF THE EMBODIMENTS

An exemplary embodiment according to the disclosure is described in detail below with reference to the attached drawings. Components having the same function are denoted by the same reference numerals in all drawings, and descriptions thereof are not repeated.

Elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any electronic devices. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory, ROM, EPROM). Examples of firmware may include microcode, writable control store, micro-programmed structure. When implemented in software or firmware, the elements of an embodiment may be the code segments to perform the necessary tasks. The software/firmware may include the actual code to carry out the operations described in one embodiment, or code that emulates or simulates the operations. The program or code segments may be stored in a processor or machine accessible medium. The “processor readable or accessible medium” or “machine readable or accessible medium” may include any medium that may store information. Examples of the processor readable or machine accessible medium that may store include a storage medium, an electronic circuit, a semiconductor memory device, a read only memory (ROM), a flash memory, a Universal Serial Bus (USB) memory stick, an erasable programmable ROM (EPROM), a floppy diskette, a compact disk (CD) ROM, an optical disk, a hard disk, etc. The machine accessible medium may be embodied in an article of manufacture. The machine accessible medium may include information or data that, when accessed by a machine, cause the machine to perform the operations or actions described above. The machine accessible medium may also include program code, instruction or instructions embedded therein. The program code may include machine readable code, instruction or instructions to perform the operations or actions described above. The term “information” or “data” here refers to any type of information that is encoded for machine-readable purposes. Therefore, it may include program, code, data, file, etc.

All or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

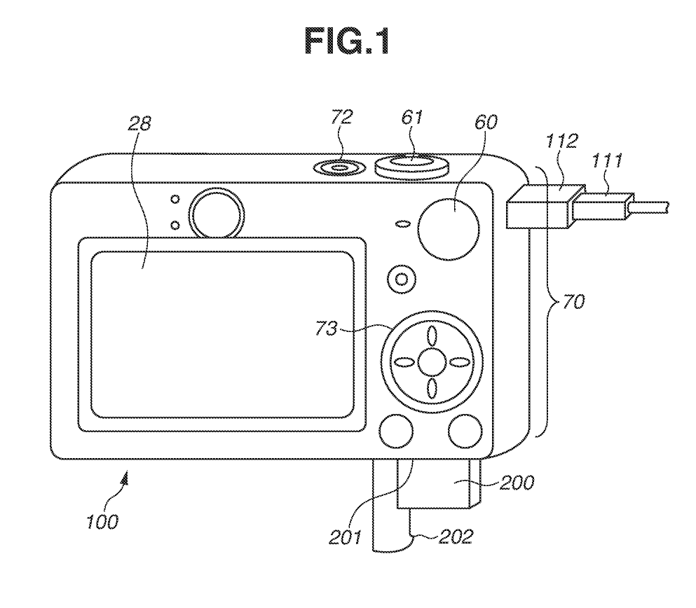

FIG. 1 is an outline view illustrating a digital camera (also referred to as an image capturing apparatus) 100 as an exemplary embodiment of an image capturing apparatus according to the disclosure. In FIG. 1, a display unit 28 displays an image and various information pieces. A shutter button 61 is an operation unit for instructing imaging. A mode selection switch 60 is an operation unit for switching various modes, such as a mode dial for switching a still image capturing mode, a moving image capturing mode, and other modes. A connector 112 connects a connection cable 111 and the digital camera 100. An operation unit 70 includes operation members such as various switches, buttons, and a touch panel for receiving various operations from a user. A controller wheel 73 is a rotatable operation member included in the operation unit 70. A power switch 72 turns a power supply on and off. A storage medium 200 includes a memory card and a hard disk. A storage medium slot 201 stores the storage medium 200. The storage medium 200 stored in the storage medium slot 201 can communicate with the digital camera 100. The storage medium slot 201 has a lid 202. The operation unit 70 may be provided with a touch panel on the display unit and operable by an external apparatus by receiving a signal therefrom.

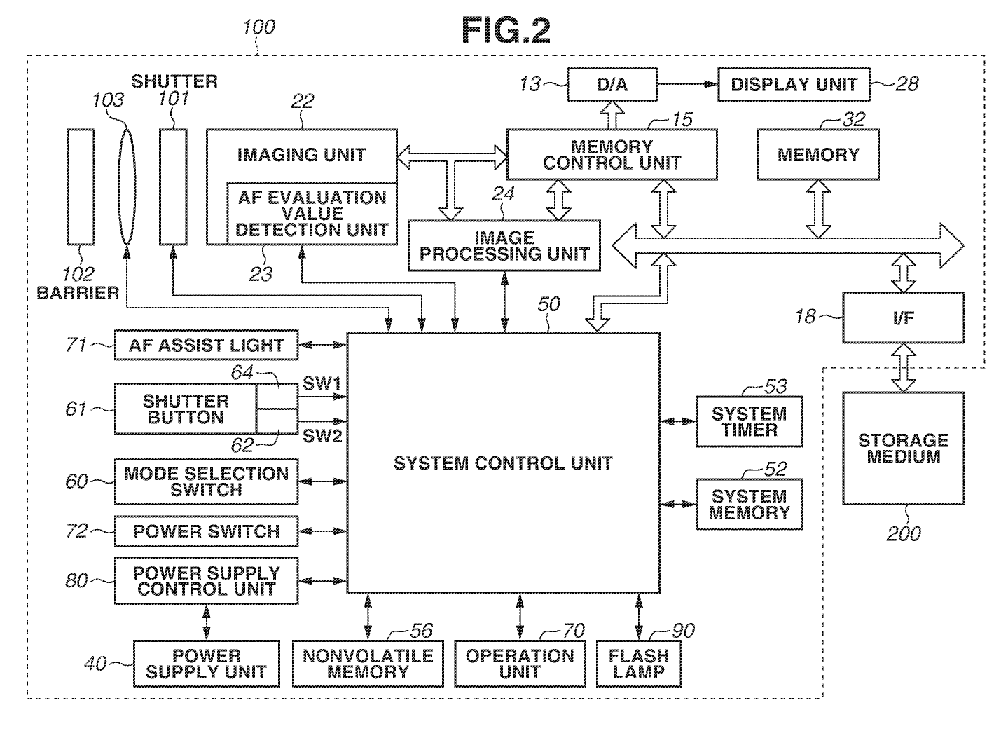

FIG. 2 is a block diagram illustrating a configuration of the digital camera 100 according to the present exemplary embodiment. In FIG. 2, an imaging lens 103 corresponding to an imaging optical system for forming an image of an object is a lens unit including a zoom lens and a focus lens. The imaging lens 103 may have a detachable and interchangeable configuration with respect to a main body of the digital camera 100. A shutter 101 has a diaphragm function. An imaging unit 22 includes an image sensor constituted of a charge coupled device (CCD), a complementary metal oxide semiconductor (CMOS), and the like for converting an optical image to an electric signal. The imaging unit 22 also has an analog-to-digital (A/D) conversion processing function of converting an electric signal based on an optical image to a digital signal as an imaging signal. An automatic focus (AF) evaluation value detection unit 23 calculates an AF evaluation value from contrast information obtained from the imaging signal and a focus detection signal of a focus detection pixel and outputs the calculated AF evaluation value from the imaging unit 22 to a system control unit 50. A barrier 102 covers an imaging system including the imaging lens 103 of the digital camera 100 to protect the imaging system including the imaging lens 103, the shutter 101, and the imaging unit 22 from dirt and damage.

An image processing unit 24 performs predetermined pixel interpolation, resizing processing such as reduction, and color conversion processing on various signals output from the imaging unit 22 or a memory control unit 15. The image processing unit 24 performs predetermined calculation processing using various signals, and the system control unit 50 performs exposure control and focus detection control based on the obtained calculation result. Accordingly, through the lens (TTL) type automatic exposure (AE) processing and flash automatic light control emission (EF) processing are performed. The image processing unit 24 performs AF processing, and an output of the AF evaluation value detection unit 23 included in the imaging unit 22 may be used for the processing. The image processing unit 24 further performs predetermined calculation processing using captured image data and TTL type automatic white balance (AWB) processing based on the obtained calculation result.

Various signals output from the imaging unit 22 are written as data directly to a memory 32 via the image processing unit 24 and the memory control unit 15 or via the memory control unit 15. The memory 32 stores various signals obtained and subjected to A/D conversion by the imaging unit 22 and data to be displayed on the display unit 28. The memory 32 has a storage capacity sufficient to store a predetermined number of still images and a moving image and sound in a predetermined time length.

The memory 32 also serves as a memory for image display (a video memory). A digital to analog (D/A) converter 13 converts image data for display stored in the memory 32 to an analog signal and supplies the analog signal to the display unit 28. Thus, the image data for display written in the memory 32 is displayed by the display unit 28 via the D/A converter 13. The display unit 28 performs display on a display device, such as a liquid crystal display (LCD) according to the analog signal from the D/A converter 13. A digital signal once subjected to A/D conversion by the imaging unit 22 and accumulated in the memory 32 is subjected to analog conversion by the D/A converter 13 and successively transferred to and displayed on the display unit 28, and thus the display unit 28 functions as an electronic view finder and performs through image display.

A nonvolatile memory 56 is an electrically erasable recordable memory and, for example, a flash memory is used. The nonvolatile memory 56 stores a constant, a program, and the like for operating the system control unit 50. A program mentioned here is a program for executing processing in various flowcharts according to the present exemplary embodiment which are described below.

The system control unit 50 includes a central processing unit (CPU) for controlling various types of calculation and the entire image capturing apparatus 100. The CPU comprehensively controls each component to entirely control the image capturing apparatus 100. In addition, the CPU performs setting of various setting parameters on each component. The CPU executes a program stored in the above-described nonvolatile memory 56 and thus realizes each processing according to the present exemplary embodiment described below. A random access memory (RAM) is used as a system memory 52. In the system memory 52, a constant and a variable for operating the system control unit 50 and a program read out from the nonvolatile memory are developed. The system control unit 50 performs display control by controlling the system memory 52, the D/A converter 13, the display unit 28, and the like. A system timer 53 is a time measurement unit for measuring time used for various types of control and time of a built-in clock.

The system control unit 50 includes an external interface (I/F) unit via the connector 112. The external I/F unit outputs a captured image and the like to the outside. An output destination includes an external control apparatus, a recorder, and an external analysis apparatus (e.g., an image recognition apparatus). Various data pieces and image signals can be input from an external apparatus such as another image capturing apparatus. Alternatively, the image capturing apparatus 100 can connect to an external computer via the external I/F unit or the Internet and obtain necessary information directly from the computer or via the Internet. The external I/F unit may be wirelessly connected based on a predetermined standard such as a wireless local area network (LAN) without being limited to a wired connection via the connector 112.

The mode selection switch 60, a first shutter switch 62, a second shutter switch 64, and the operation unit 70 are operation units for inputting various operation instructions to the system control unit 50. The mode selection switch 60 switches an operation mode of the system control unit 50 to any mode including the still image capturing mode, the moving image capturing mode, a reproduction mode, and others. The still image capturing mode includes an auto imaging mode, an auto scene determination mode, a manual mode, various scene modes as imaging settings for respective scenes, a program AE mode, and a custom mode. The mode selection switch 60 can switch directly to any of these modes included in the still image capturing mode. Alternatively, the operation mode may be once switched to the still image capturing mode by the mode selection switch 60 and then further switched to any of these modes included in the still image capturing mode using another operation member. Similarly, the moving image capturing mode may include a plurality of modes. The still image capturing mode further includes a consecutive imaging mode. When the consecutive imaging mode is selected, an operation for consecutively obtaining still images is performed while the second shutter switch 64 is continuously operated. The digital camera 100 according to the present exemplary embodiment can obtain ten or more still images in a second and perform focus detection during consecutive imaging by obtaining a focus detection signal described below.

The first shutter switch 62 is turned ON in a middle of an operation, namely half pressing (an imaging preparation instruction) on the shutter button 61 of the digital camera 100 and generates a first shutter switch signal SW1. By the first shutter switch signal SW1, operations of AF processing, AE processing, AWB processing, EF processing, EF processing, and other processing are started.

The second shutter switch 64 is turned ON by completion of an operation, namely full pressing (an imaging instruction) on the shutter button 61 and generates a second shutter switch signal SW2. The system control unit 50 starts a series of imaging processing operations from reading of a signal from the imaging unit 22 to writing of image data to the storage medium 200 by the second shutter switch signal SW2.

Each operation member of the operation unit 70 is appropriately assigned with a function according to a situation by a selection operation on various function icons displayed on the display unit 28 and acts as various function buttons. The function button includes, for example, an end button, a return button, an image feed button, a jump button, a narrowing-down button, and an attribute change button. For example, when a menu button is pressed, a menu screen on which various settings can be performed is displayed on the display unit 28. A user can intuitively perform various settings using the menu screen displayed on the display unit 28, a four-direction button for vertical and horizontal directions, and a SET button.

An AF assist light 71 illuminates an object with light when brightness is low. The controller wheel 73 is a rotatable operation member included in the operation unit 70 and is used when instructing a selection item together with the direction button. When the controller wheel 73 is rotated, an electric pulse signal is generated according to an operation amount, and the system control unit 50 controls each unit in the digital camera 100 based on the pulse signal. An angle of the rotation operation on the controller wheel 73 and how many times the controller wheel 73 is rotated can be determined based on the pulse signal. The controller wheel 73 may be any type of operation member as long as it can detect a rotation operation. For example, a dial operation member may be used which generates a pulse signal by rotation of the controller wheel 73 itself in response to a rotation operation by a user. In addition, an operation member constituted of a touch sensor may be used in which the controller wheel 73 itself does not rotate but detects a rotation motion of a user's finger and the like on the controller wheel 73 (namely, a touch wheel).

A power supply control unit 80 is constituted of a battery detection circuit, a direct current to direct current (DC-DC) converter, a switch circuit for switching an energizing block, and the like and detects whether a battery is mounted and a type and a remaining amount of the battery. The power supply control unit 80 controls the DC-DC converter based on the detected result and an instruction from the system control unit 50 and supplies a necessary voltage for a necessary period to each unit including the storage medium 200.

A power supply unit 40 includes a primary battery such as an alkaline battery, a secondary battery such as a lithium (Li) ion battery, and an alternate current (AC) adapter. A storage medium I/F 18 is an interface with the storage medium 200 such as a memory card. The storage medium 200 includes a memory card for recording a captured image and is constituted of a semiconductor memory and the like.

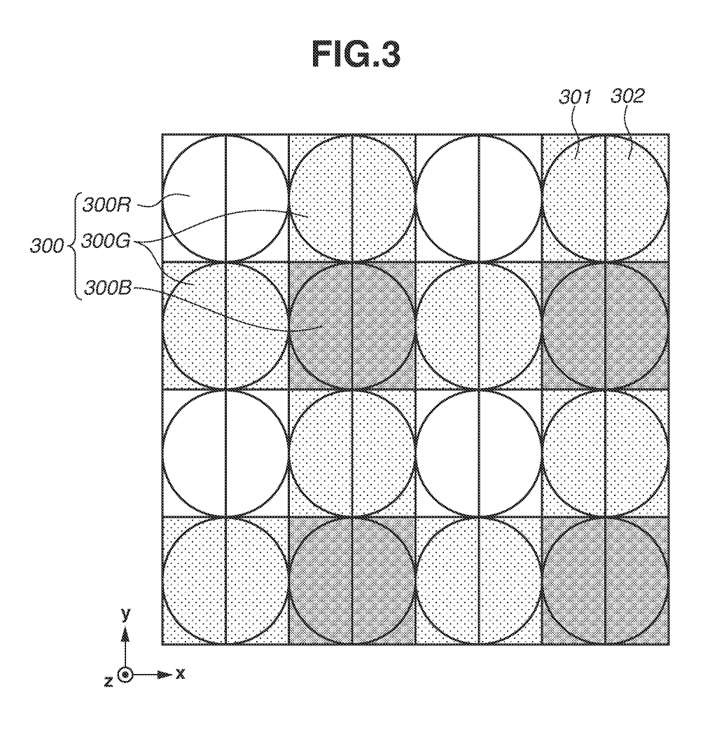

FIG. 3 illustrates a pixel array of a two-dimensional complementary metal oxide semiconductor (CMOS) sensor as an exemplary embodiment of the image sensor included in the imaging unit 22 according to the present exemplary embodiment in a range of four columns by four rows and a focus detection pixel array in a range of eight columns by four rows.

According to the present exemplary embodiment, a pixel 300R having a spectral sensitivity in red (R) is arranged on an upper left position, pixels 300G having a spectral sensitivity in green (G) are arranged on an upper right position and a lower left position, and a pixel 300B having a spectral sensitivity in blue (B) is arranged on a lower right position in a pixel group 300 of two columns by two rows illustrated in FIG. 3. Further, each pixel is constituted of a first focus detection pixel 301 and a second focus detection pixel 302 arranged in two columns by one row. A large number of pixels in four columns by four rows (the focus detection pixels of eight columns by four rows) illustrated in FIG. 3 is arranged on a plane, and thus a captured image (a focus detection signal) can be obtained. According to the present exemplary embodiment, the image sensor is described of which a pixel period P is 4 μm, the number of pixels N is approximately 20.75 million pixels of 5575 horizontal columns by 3725 vertical rows, a column direction period PAF of a focus detection pixel is 2 μm, and the number of focus detection pixels NAF is approximately 41.50 million pixels of 11150 horizontal columns by 3725 vertical rows.

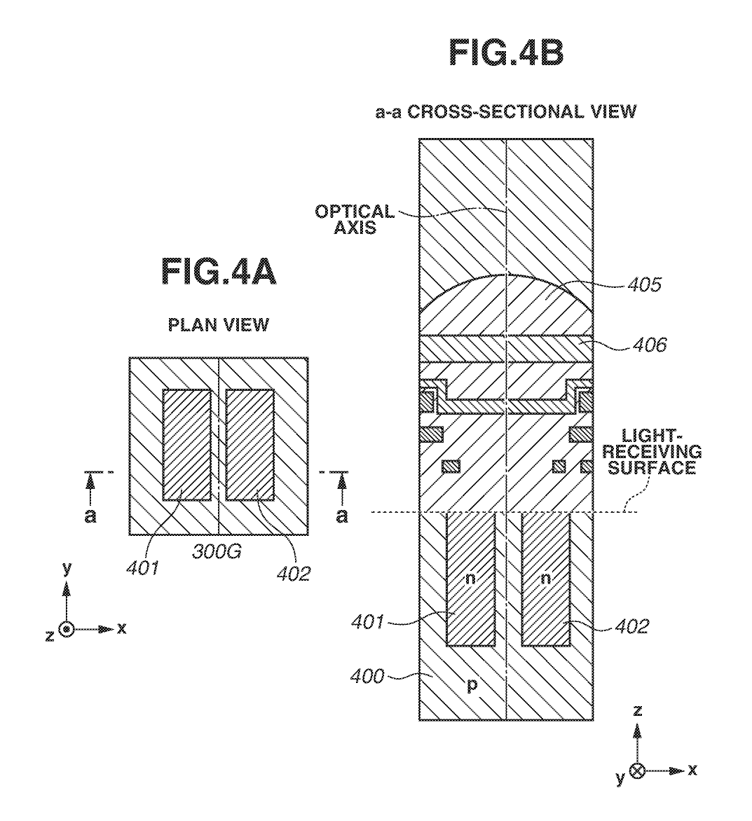

FIG. 4A is a plan view of one of the pixel 300G in the image sensor illustrated in FIG. 3 viewed from a light-receiving surface side (+z side) of the image sensor, and FIG. 4B is a cross-sectional view of an a-a cross-section in FIG. 4A viewed from a −y side.

As illustrated in FIGS. 4A and 4B, the pixel 300G according to the present exemplary embodiment includes a microlens 405 formed for condensing incident light to a light-receiving side of each pixel and a photoelectric conversion unit 401 and a photoelectric conversion unit 402 which are formed through numpy hsplit (NH split) (2 split) in an x direction and numpy vsplit (NV split) (1 division) in a y direction. The photoelectric conversion unit 401 and the photoelectric conversion unit 402 respectively correspond to the first focus detection pixel 301 and the second focus detection pixel 302. The number of photoelectric conversion units formed in one pixel may be two or more.

The photoelectric conversion unit 401 and the photoelectric conversion unit 402 may be a PIN diode which has an intrinsic layer between a p-type layer and an n-type layer or may be a PN junction photodiode by omitting an intrinsic layer as needed.

Each pixel includes the microlens 405 and a color filter 406 formed between the photoelectric conversion unit 401 and the photoelectric conversion unit 402. In addition, spectral transmittance of the color filter may be changed for each sub-pixel, or the color filter may be omitted as needed.

Light incident on the pixel 300G illustrated in FIGS. 4A and 4B is condensed by the microlens 405, dispersed by the color filter 406, and then received by the photoelectric conversion unit 401 and the photoelectric conversion unit 402. In the photoelectric conversion unit 401 and the photoelectric conversion unit 402, a pair of an electron and a hole is produced according to an amount of received light, is separated by a depletion layer, then the negative charge electron is accumulated on the n-type layer (not illustrated), and the hole is discharged to the outside of the image sensor via the p-type layer connected to a constant voltage power supply (not illustrated). The electrons accumulated on the n-type layer (not illustrated) of the photoelectric conversion unit 401 and the photoelectric conversion unit 402 are transferred to a capacitance unit (FD) via a transfer gate and converted to voltage signals.

In the image sensor according to the present exemplary embodiment, a plurality of imaging pixels including the first focus detection pixel 301 and the second focus detection pixel 302 is arranged. The first focus detection pixel 301 receives a light flux passing through a first pupil portion area of the imaging optical system. The second focus detection pixel 302 receives a light flux passing through a second pupil portion area of the imaging optical system which is different from the first pupil portion area. The imaging pixel receives a light flux passing through a pupil area combining the first pupil portion area and the second pupil portion area of the imaging optical system. In the image sensor according to the present exemplary embodiment, each imaging pixel is constituted of the first focus detection pixel 301 and the second focus detection pixel 302. In addition, the imaging pixel, the first focus detection pixel 301, and the second focus detection pixel 302 may be configured as an individual pixel, and the first focus detection pixel and the second focus detection pixel may be partly arranged in a part of the imaging pixel array as needed.

According to the present exemplary embodiment, a first focus detection signal is generated by collecting a light receiving signal of the first focus detection pixel 301 of each pixel, a second focus detection signal is generated by collecting a light receiving signal of the second focus detection pixel 302 of each pixel in the image sensor, and thus focus detection is performed. Further, signals of the first focus detection pixel 301 and the second focus detection pixel 302 are added for each pixel in the image sensor, and thus an imaging signal having resolution of the number of effective pixels N is generated.

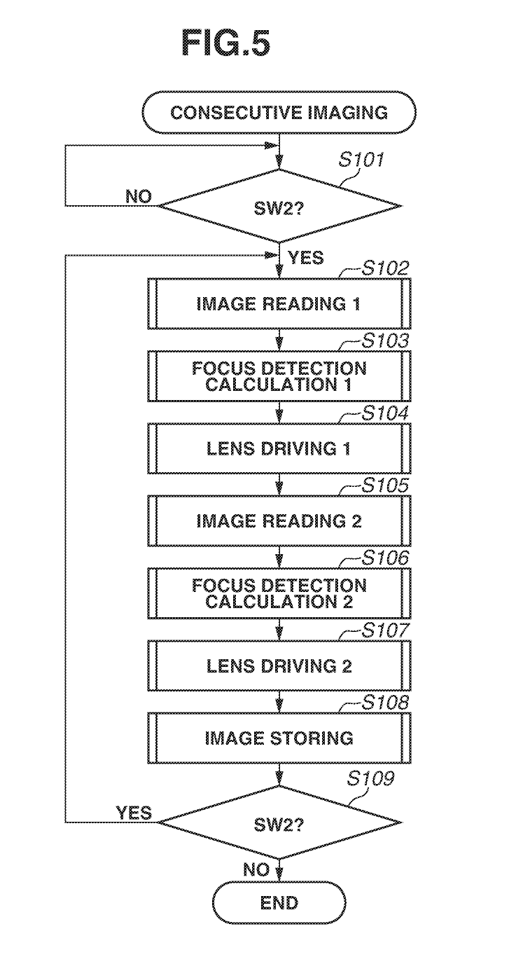

FIG. 5 is a flowchart illustrating a consecutive imaging sequence according to the present exemplary embodiment. Processing in the present flowchart is performed by the system control unit 50 controlling each component.

First, in step S101, the system control unit 50 detects whether the second shutter switch 64 is pressed in the consecutive imaging mode. When pressing of the second shutter switch 64 is detected (YES in step S101), the system control unit 50 starts the flow of consecutive imaging, and exposure is started on each pixel.

In step S102, the system control unit 50 reads a pixel for first focus detection calculation (a first focus detection pixel area) from the imaging unit 22.

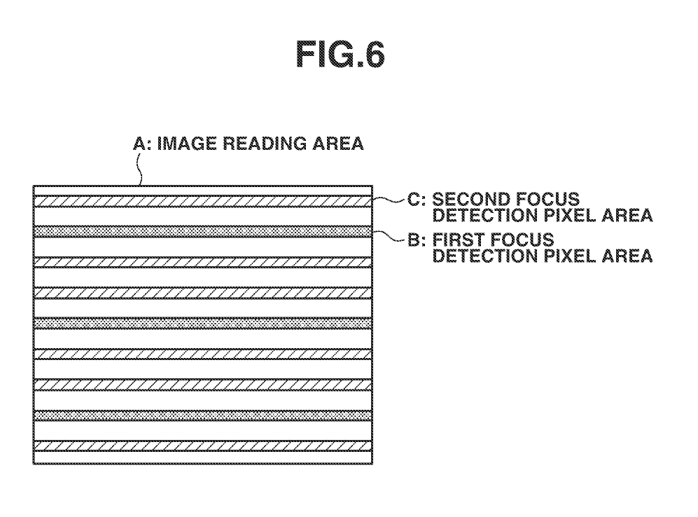

Subsequently, the system control unit 50 advances the processing to step S103. The pixel for first focus detection calculation is a pixel corresponding to a part of pixels two-dimensionally arranged on the image sensor included in the imaging unit 22 and corresponding to a pixel included in a discrete area with respect to an entire area of the image sensor. The pixel for first focus detection calculation is described in detail below with reference to FIG. 6.

In step S103, the system control unit 50 performs the first focus detection calculation using a focus detection signal from the pixel read in step S102. The first focus detection calculation is executed based on a phase difference between a first focus detection signal and a second focus detection signal corresponding to signals read from the pixel for first focus detection calculation. According to the present exemplary embodiment, the number of pixels for first focus detection calculation is less than 20% of the total number of pixels of the image sensor. Thus, pixels can be read at high speed, however, focus detection accuracy sufficient for capturing a still image cannot be obtained in some cases. Therefore, the first focus detection calculation is performed for determining a lens driving direction and a temporary target position (a first in-focus position) of lens driving. After the lens driving direction and the first in-focus position are determined, the system control unit 50 advances the processing to step S104.

In step S104, the system control unit 50 starts driving of the focus lens included in the imaging lens 103 using the lens driving direction and the first in-focus position determined in step S103. Subsequently, the system control unit 50 advances the processing to step S105.

In step S105, the system control unit 50 reads a pixel for second focus detection calculation (a second focus detection pixel area) from the imaging unit 22. Subsequently, the system control unit 50 advances the processing to step S106. The pixel for second focus detection calculation is a pixel corresponding to a part of pixels two-dimensionally arranged on the image sensor included in the imaging unit 22 and corresponding to a pixel included in a discrete area with respect to the entire area of the image sensor which is different from the pixel for first focus detection calculation. The pixel for second focus detection calculation is also described in detail below with reference to FIG. 6. The processing in step S105 may be performed in parallel with the first focus detection calculation in step S103 or driving of the imaging lens 103 in step S104.

In step S106, the system control unit 50 performs the second focus detection calculation using a focus detection signal from the pixel read in step S105. The second focus detection calculation is executed based on a phase difference between a first focus detection signal and a second focus detection signal corresponding to signals read from the pixel for second focus detection calculation. According to the present exemplary embodiment, the number of pixels for second focus detection calculation is greater than the number of pixels for first focus detection calculation in order to improve the focus detection accuracy. Thus, the focus detection accuracy sufficient for capturing a still image can be obtained. Therefore, the second focus detection calculation enables determination of a target position (a second in-focus position) of the lens driving used for next image capturing with a high degree of accuracy. When emphasis is placed on a reading speed, the number of pixels for second focus detection calculation is not necessarily greater than the number of pixels for first focus detection calculation. When the number of pixels for second focus detection calculation is not sufficient to determine the second in-focus position, the result of the first focus detection calculation may be included thereto. Specifically, calculation accuracy can be improved by determining an in-focus position by adding a correlation calculation result for calculating a phase difference to the first focus detection calculation and the second focus detection calculation.

In step S107, the system control unit 50 drives the focus lens included in the imaging lens 103 using the second in-focus position determined in step S106. Subsequently, the system control unit 50 advances the processing to step S108.

In step S108, the system control unit 50 reads an imaging signal from a remaining pixel which is not yet read in an area other than areas of the pixel for first focus detection calculation and the pixel for second focus detection calculation, performs predetermined processing thereon, and stores the imaging signal in the storage medium 200 as image data. Subsequently, the system control unit 50 advances the processing to step S109.

In step S109, the system control unit 50 repeats the processing from step S102 to step S108 while the second shutter switch 64 is kept pressed.

According to the processing in the flowchart illustrated in FIG. 5, signals are read from a small number of pixels for first focus detection calculation in advance at high speed, and thus driving of the focus lens can be tentatively started. Further, the second focus detection calculation is performed using a focus detection signal to be subsequently read, and focus detection calculation can be performed with a high degree of accuracy. Accordingly, high-speed capability and high accuracy can be both attained in the imaging plane AF.

FIG. 6 illustrates an image reading area according to the present exemplary embodiment. An entire image reading area is indicated by symbol A. One image is generated by reading a signal from each pixel in the entire area. In the image reading area, a pixel does not output a focus detection signal but outputs only an imaging signal. On the other hand, the first focus detection pixel area indicated by symbol B is discretely arranged in a vertical direction with respect to the image reading area, and an imaging signal and a focus detection signal are both read therefrom. The second focus detection pixel area indicated by symbol C is discretely arranged in the vertical direction with respect to the image reading area, and an imaging signal and a focus detection signal are both read therefrom in a similar manner. A point common to the first focus detection pixel area and the second focus detection pixel area is that the both focus detection pixel areas are discretely arranged in the vertical direction. Since a reading direction of the present exemplary embodiment is to perform scan in the vertical direction, reading can be efficiently performed by discretely arranging the focus detection pixel areas in the reading direction. In addition, respective discrete areas may include a plurality of rows. The first focus detection pixel area and the second focus detection pixel area are different from each other in the number of pixels to be read. More specifically, according to the present exemplary embodiment, the number of pixels included in the first focus detection pixel area is less than the number of pixels included in the second focus detection pixel area. This is because a focus detection signal obtained from the first focus detection pixel area is aimed at determination of the first in-focus position as a tentative in-focus position, and thus a small number of pixels is sufficient. Specifically, when an object is bright, a signal to noise ratio (S/N) of the focus detection signal is high in a low sensitivity, so that the first focus detection pixel areas are lessened, and a reading time from the image sensor and a calculation amount in the first focus detection calculation can be reduced. Accordingly, an initial motion of the imaging lens 103 can be quickened. In this regard, in the case of a high sensitivity when an object is dark, the S/N of an image signal is low, so that the first focus detection pixel areas are increased, and AF accuracy can be prioritized. When the first focus detection pixel areas are increased, the second focus detection pixel areas may be lessened with respect to the increased amount. In addition, when the S/N is changed according to a temperature other than the sensitivity, the first focus detection pixel areas may be increased in response to the change. A setting of each area is performed by the system control unit 50.

The first focus detection pixel areas and the second focus detection pixel areas are not necessarily arranged at equal intervals as illustrated in FIG. 6. For example, the S/N is low at an image peripheral portion, so that the first focus detection pixel areas may be densely arranged (many rows may be arranged). In addition, the first focus detection pixel areas may be densely arranged in an area designated by a user.

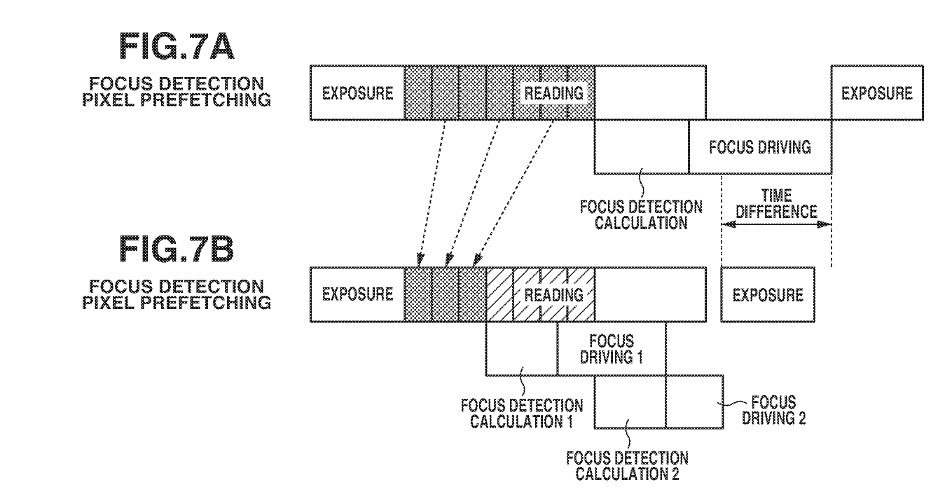

FIGS. 7A and 7B are timing charts of an image reading order according to the present exemplary embodiment. FIG. 7A illustrates a reading order of focus detection pixels corresponding to a normal imaging timing which is not in the consecutive imaging mode. When an exposure operation of the imaging unit 22 is completed, the shutter 101 is shielded, and a reading operation is started. First, prefetching is performed on the focus detection pixel areas, and focus detection calculation is started after reading. On the other hand, in FIG. 7B, prefetching is performed on the first focus detection pixel areas, and the first focus detection calculation is started as illustrated in the flowchart in FIG. 5. Further, the second focus detection pixel areas are read in parallel, and then remaining pixels are read. The first focus detection calculation is started when the first focus detection pixel areas are read. As can be understood from comparison of FIGS. 7A and 7B, the imaging lens 103 is driven when the first focus detection calculation is completed, and thus a time length to next imaging can be shortened than the conventional reading method. Further, the second focus detection calculation is performed during driving of the imaging lens 103, and thus AF control can be executed more accurately. According to the present exemplary embodiment, the entire image reading area is collectively reset at the start of exposure, and light is shielded by closing a mechanical shutter when the exposure is ended. An image sensor which can perform a shutter operation in a global shutter method in which each pixel includes a memory does not necessarily have to use a mechanical shutter.

As illustrated in the timing charts in FIGS. 7A and 7B, the imaging signals are read in the vertical direction with respect to image data in a random order in the image reading area. Therefore, the image signals are to be sorted in order to finally generate the image data. This operation can be realized by controlling the memory control unit 15 to control the order to store the image signals in the memory 32.

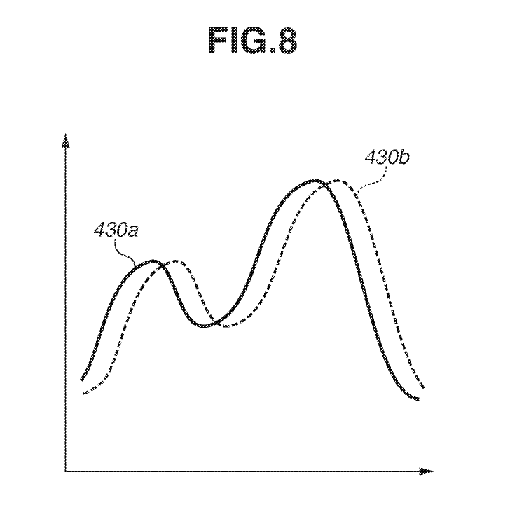

FIG. 8 illustrates calculation of the imaging plane AF according to the present exemplary embodiment. FIG. 8 illustrates a pair of focus detection signals which are photoelectrically converted by the imaging unit (the image sensor) 22, subjected to various types of correction by the image processing unit 24, and then transmitted to the AF evaluation value detection unit (an imaging plane phase difference focus detection unit) 23. In FIG. 8, an abscissa axis indicates a pixel arrangement direction of a connected signal, and an ordinate axis indicates intensity of the signal. A focus detection signal 430a and a focus detection signal 430b are signals respectively formed by a focus detection pixel SHA and a focus detection pixel SHB. Since the imaging lens 103 is in a defocus state with respect to the imaging unit 22, the focus detection signal 430a is deviated to a left side, and the focus detection signal 430b is deviated to a right side. Deviated amounts of the focus detection signals 430a and 430b are calculated using known correlation calculation by the AF evaluation value detection unit 23, and thus how much the imaging lens 103 is defocused can be understood. The system control unit 50 calculates a focus lens driving amount from lens position information of the imaging lens 103 and the defocus amount obtained from the AF evaluation value detection unit 23. Subsequently, the system control unit 50 transmits position information to which the imaging lens 103 is driven based on the focus lens position information. Accordingly, focusing by the imaging lens 103 can be performed.

Regarding the above-described correlation calculation, there is a method for correlating per pixel to improve AF accuracy, however, correlation can be obtained at an interval of two or more pixels in the correlation calculation of the first focus detection calculation in order to make an initial motion of the imaging lens 103 more quicker. Second correlation calculation can be performed per pixel so as not to reduce a focusing accuracy of AF.

When the focus detection signal 430a and the focus detection signal 430b highly correlate with each other as a result of the first focus detection calculation using the focus detection signal 430a and the focus detection signal 430b, the focus detection signal 430a and the focus detection signal 430b are not suitable for calculating a defocus amount since it is difficult to obtain a peak of correlation scan. Therefore, a calculation range may be changed so that the second focus detection calculation is performed near a line at which correlation between the focus detection signal 430a and the focus detection signal 430b is low, and thus the focusing accuracy can be improved while making an initial motion of the imaging lens 103 quicker.

While the present disclosure has been described in detail above with reference to exemplary embodiments, it is to be understood that the disclosure is not limited to the described specific exemplary embodiments, and various embodiments without departing from the scope of the disclosure are included in the present disclosure. A part of the above-described exemplary embodiments may be appropriately combined. Further, the present disclosure includes a case in which a software program for realizing functions of the above-described exemplary embodiments is supplied from a storage medium directly or using wired/wireless communication to a system or an apparatus including a computer capable of executing the program, and the program is executed. Thus, a program code itself to be supplied and installed to the computer for realizing function processing of the present disclosure by the computer realizes the present disclosure. In other words, a computer program itself for realizing the function processing of the present disclosure is included in the present disclosure. In this case, a program may be in any form such as object code, a program executed by an interpreter, and script data supplied to an operating system (OS) as long as the form has a function of the program. A storage medium supplying the program may include, for example, a hard disk, a magnetic storage medium such as a magnetic tape, an optical/magneto-optical storage medium, and a nonvolatile semiconductor memory. As a method for supplying the program, a method can be considered in which a computer program forming the present disclosure is stored in a server on a computer network, and a client computer connected to the network downloads and executes the computer program.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-133939, filed Jul. 7, 2017, which is hereby incorporated by reference herein in its entirety.

What is claimed is:

1. An apparatus including an image sensor capable of obtaining a focus detection signal for performing focus detection of an imaging optical system and an imaging signal for generating image data for display, the apparatus comprising:
a setting unit configured to set a plurality of areas from which focus detection signals are obtained in the image sensor; and
a calculation unit configured to perform focus detection calculation of the imaging optical system based on the focus detection signal read from each of the plurality of areas,
wherein the setting unit sets a first area and a second area from which focus detection signals are obtained in the image sensor, and
wherein the calculation unit calculates a first in-focus position based on a focus detection signal read from the first area and calculates a second in-focus position based on a focus detection signal read from the second area while a focus lens of the imaging optical system is driven based on the first in-focus position.

2. The apparatus according to claim 1, wherein the first area and the second area are discretely arranged in the image sensor.

3. The apparatus according to claim 1, further comprising a reading unit configured to read a signal for each row from the image sensor,
wherein the reading unit reads a focus detection signal from the first area and subsequently reads a focus detection signal from the second area.

4. The apparatus according to claim 3, wherein the reading unit reads a focus detection signal and an imaging signal from the first area and the second area and reads only an imaging signal from an area other than the first area or the second area.

5. The apparatus according to claim 1, wherein a number of pixels included in the first area is less than a number of pixels included in the second area.

6. The apparatus according to claim 1, wherein the setting unit changes a number of pixels included in the first area based on at least any of a sensitivity and a temperature.

7. The apparatus according to claim 1, wherein a calculation amount based on the second area in the calculation unit is greater than a calculation amount based on the first area.

8. The apparatus according to claim 1, wherein the calculation unit changes a calculation range based on the second area according to a calculation result based on the first area.

9. A method for controlling an apparatus including an image sensor capable of obtaining a focus detection signal for performing focus detection of an imaging optical system and an imaging signal for generating image data for display, the method comprising:
setting a plurality of areas from which focus detection signals are obtained in the image sensor;
performing focus detection calculation of the imaging optical system based on the focus detection signal read from each of the plurality of areas;
setting a first area and a second area from which focus detection signals are obtained in the setting; and
calculating a first in-focus position based on a focus detection signal read from the first area and calculating a second in-focus position based on a focus detection signal read from the second area while a focus lens of the imaging optical system is driven based on the first in-focus position in the calculating.

10. The method according to claim 9, wherein the first area and the second area are discretely arranged in the image sensor.

11. The method according to claim 9, further comprising reading a signal for each row from the image sensor,
wherein the reading reads a focus detection signal from the first area and subsequently reading a focus detection signal from the second area.

12. The method according to claim 9, wherein a number of pixels included in the first area is less than a number of pixels included in the second area.

13. The method according to claim 9, wherein the setting changes a number of pixels included in the first area based on at least any of a sensitivity and a temperature.

14. The method according to claim 9, wherein a calculation amount based on the second area in the calculating is greater than a calculation amount based on the first area.

15. A computer readable storage medium storing a computer-executable program of instructions for causing a computer to perform a method for controlling an apparatus including an image sensor capable of obtaining a focus detection signal for performing focus detection of an imaging optical system and an imaging signal for generating image data for display, the method comprising:
setting a plurality of areas from which focus detection signals are obtained in the image sensor;
performing focus detection calculation of the imaging optical system based on the focus detection signal read from each of the plurality of areas;
setting a first area and a second area from which focus detection signals are obtained in the setting; and
calculating a first in-focus position based on a focus detection signal read from the first area and calculating a second in-focus position based on a focus detection signal read from the second area while a focus lens of the imaging optical system is driven based on the first in-focus position in the calculating.

16. The computer readable storage medium according to claim 15, wherein the first area and the second area are discretely arranged in the image sensor.

17. The computer readable storage medium according to claim 15, further comprising reading a signal for each row from the image sensor,
wherein the reading reads a focus detection signal from the first area and subsequently reading a focus detection signal from the second area.

18. The computer readable storage medium according to claim 15, wherein a number of pixels included in the first area is less than a number of pixels included in the second area.

19. The computer readable storage medium according to claim 15, wherein the setting changes a number of pixels included in the first area based on at least any of a sensitivity and a temperature.

20. The computer readable storage medium according to claim 15, wherein a calculation amount based on the second area in the calculating is greater than a calculation amount based on the first area.
